(19) United States
(12) Patent Application Publication
(10) Pub. No.: US 2017/0124587 A1
(43) Pub. Date: May 4, 2017

(54) SYSTEMS AND METHODS TO INCREASE INVENTORY REDUCTION

(71) Applicant: NCR Corporation, Duluth, GA (US)

(72) Inventor: Daniel Frederick White, Flowery Branch, GA (US)

(21) Appl. No.: 14/928,537

(22) Filed: Oct. 30, 2015

(51) Int. Cl. G06Q 30/02

(52) U.S. Cl. CPC G06Q 30/0238; G06Q 30/0268; G06Q 30/0226; G06Q 30/0269

(57) ABSTRACT

Various embodiments herein include systems, methods, and software to increase inventory reduction for many purposes. One method embodiment includes retrieving, by a Point-of-Sale (POS) terminal, promotion data during an open checkout transaction. The retrieved promotional data typically includes a promotion detail portion and a promotion rule. The method further presents a view of at least the promotion detail portion of the retrieved promotional data, either via a display of a teller or a customer facing display. This method may further apply the promotion rule to the transaction when one or more specific items presented for purchase are implicated by the promotion rule.

### BACKGROUND INFORMATION

Retailers seek to maximize inventory turnover and to maximize sales opportunities. While great effort is made in doing so, certain items often are neglected and items become out of date, spoil, or otherwise occupy shelf-space for long periods. Further, certain items are high-margin sales items that retailers profit from considerably as a percentage of retailer cost. Selling such items is a goal and technical solutions for doing so are lacking in many regards.

### SUMMARY

Various embodiments herein include systems, methods, and software to increase inventory reduction for many purposes. One method embodiment includes retrieving, by a Point-of-Sale (POS) terminal, promotion data during an open checkout transaction. The retrieved promotional data typically includes a promotion detail portion and a promotion rule. The method further presents a view of at least the promotion detail portion of the retrieved promotional data, either via a display of a teller or a customer facing display. This method may further apply the promotion rule to the transaction when one or more specific items presented for purchase are implicated by the promotion rule.

### BRIEF DESCRIPTION OF THE DRAWINGS

FIG. 1 is a logical block diagram of a system architecture, according to an example embodiment.

FIG. 2 is a diagram illustrating components of a checkout station having a scanner, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein include systems, methods, and software to increase inventory reduction for many purposes. Such purposes may be to increase sales and to sell items that are about to become out of date such as periodical publications, fresh food and plant items, and the like. There are other purposes or goals that may be utilized to move such goods, such as promoting sales of items that have otherwise been slow to sell.

Previous efforts have provided promotion offers printed on sales receipts. However, the modern computing environment provides additional opportunities that are provided herein. For example, during a transaction at a POS terminal, promotion data may be retrieved and presented to a customer either orally by a cashier, via a customer facing display, through illumination of a product attraction feature such as a blinking light or display located near a product that is the subject of a promotion, via a text or in app message on a mobile device of the customer when the customer is known, and the like.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

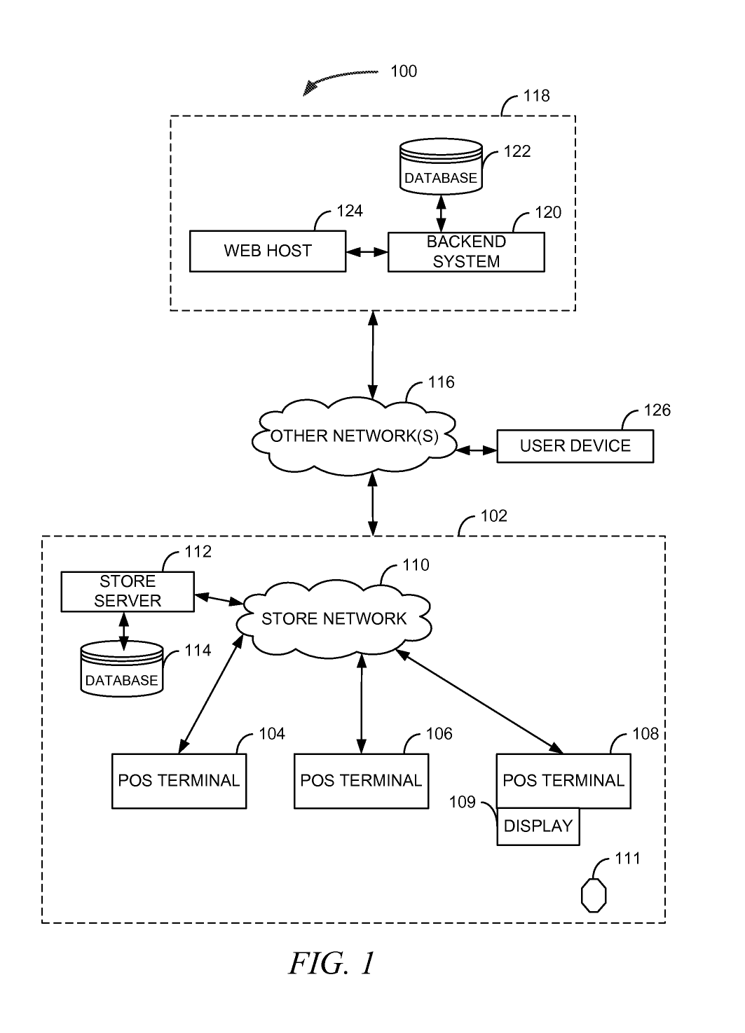

FIG. 1 is a logical block diagram of a system 100 architecture, according to an example embodiment. The system 100 is an example of a computing environment within which various embodiments may be implemented. The system 100 architecture is provided as only one example architecture on which some embodiments may be implemented. Other architectures may be utilized in other embodiments.

The system 100 includes a store 102 and a remote data processing center 118. The remote data processing center, in some embodiments, may be a corporate or regional data processing center of an entity that operates the store 102. In other embodiments, the data processing center 118 may be operated by an entity providing transaction processing services with regard to transaction data received from stores 102 over one or more other networks 116, such as a wide area network, the Internet, and the like. Thus, although only a single store 102 is illustrated, in various embodiments there may be many stores 102.

The store 102, as illustrated, includes three POS terminals 104, 106, 108 connected to a store network 110. In some embodiments, the store 102 also includes a store server 112 that may include a database 114 thereon or as may otherwise be accessible via the store network 110. Although three POS terminals 104, 106, 108 are illustrated, the store 102 may include fewer or greater numbers of POS terminals. The POS terminals 104, 106, 108 may include one or a combination of various terminal types. For example, the POS terminals 104, 106, 108 may include standard cashier operated POS terminals, self-checkout terminals where a clerk attending to one or more of such terminals may be called to provide age verification input, a mobile device terminal (e.g., a POS app that executes on a mobile telephone, computer, or tablet), and the like. Generally speaking, the POS terminals 104, 106, 108 are a form of computing device that executes software to process purchase transactions, receive input with regard to tendered payments, to locally store or provide data with regard to processed purchase transactions to at least one computing system, such as a store server 112 and a backend system 120, and to obtain and provide promotional information to customers during a checkout transaction. Note however that in some embodiments, a user device 126, such as a smartphone, tablet, personal computer, or other device may be used as or in conjunction with a POS terminal. The POS terminals 104, 106, 108, such as POS terminal, may include a display 109 that is oriented in a customer facing manner. The display 109 may be utilized to present transaction information and promotion related information to a customer. Further, a process that executes on one or more of the POS terminals 104, 106, 108, the store server 112, and the backend system 120 may communicate transaction details to the user device 126 which may include not only receipts, but promotion information while a transaction being conducted is still open, such as to encourage the customer of the user device 126 to purchase one or more additional items. The promotion data may be communicated to the user device 126, as may be known based on presentment of a customer loyalty account card, a customer phone number or account number associated with a loyalty account, or otherwise.

As mentioned, the store 102 may also include a store server 112 in some embodiments. The store server 112 may receive transaction data from the POS terminals 104, 106, 108 and process the transactions thereon or forward the transaction data to the backend system 120 for processing. The store server 112 may store received transaction data to a database 114 or the POS terminals 104, 106, 108 may instead store such data directly to the database 114 via the store network 110. The store server 112 may also include a service that provides promotion data to the POS terminals 104, 106, 108 either within open transactions or as updates to promotion data stored on the POS terminals 104, 106, 108.

However, not all embodiments will include a store server 112 and database 114 within the store 102. In other embodiments where the store 102 does not include a store server 112 and database 114, the transaction data may instead be provided by the POS terminals 104, 106, 108 to a backend system 120 and database 122 located in a data processing center 118 accessible via one or more of the store network 110 and one or more other networks 116. The one or more other networks 116 may include one or more of a virtual private network, a wide area network, the Internet, a network operated by a wireless service provider, dedicated and leased networks, and the like. Regardless of the network and network types over which the data may be provided to the backend system 120 and database 122, the data may be provided from the POS terminals 104, 106, 108 in either a push or pull types of arrangements.

The backend system 120 may also or alternatively provide a promotion service that provides promotion data to the POS terminals 104, 106, 108 either within open transactions or as updates to promotion data stored on the POS terminals 104, 106, 108. The promotion service of the backend system 120 may also provide promotion data to the store server 112 which may then be distributed to the POS terminals 104, 106, 108.

In some embodiments, the one or more product attraction feature devices 111 may be located in proximity to respective products that may be the subject of a promotion as represented in promotion data provided to customers while conducting a transaction at a POS terminal 104, 106, 108. A product attraction feature device 111 may include a light emitting diode array or other elements capable of outputting an audio or visual cue to gain a customer's attention. In such embodiments, when a customer is presented with promotion data with regard to a product, a transceiver device of a POS terminal 204, 106, 108 may send an activation signal to a transceiver device of the product attraction feature device 111. When activated, the product attraction feature device 111 activates its audio or visual cue to attract the customer's attention to aid the customer in locating the product that is the subject of the promotion. This can not only aid in helping the customer quickly find the product, but also may help ensure the effort of providing in-transaction promotions does not slow the checkout process needlessly.

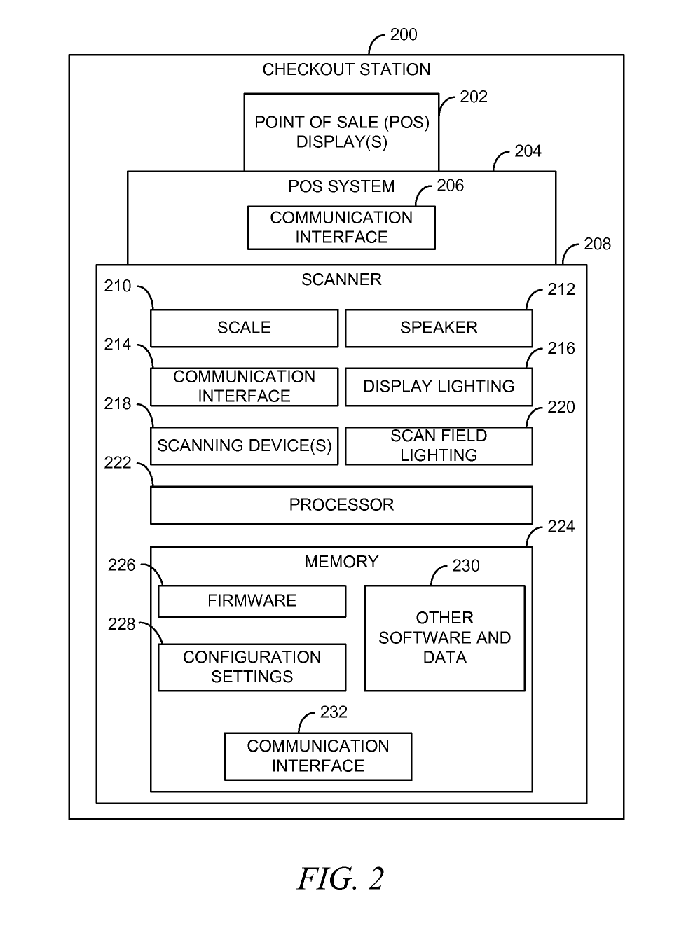

FIG. 2 is a diagram illustrating components of a checkout station 200 having a scanner 208, according to an example embodiment. It is to be noted that the checkout station 200 is shown schematically in greatly simplified form, with example components relevant to understanding various embodiments herein. The same situation may be true for the other various components of the checkout station 200. Note that the checkout station 200 may include more or fewer components in some embodiments.

Furthermore, the various components included in the FIG. 2 as illustrated and arranged are provided for illustration purposes only. It is to be noted that other arrangements with more or fewer components are possible without departing from the contributions herein, in particular with regard to automatic and remote scanner configuration.

Moreover, the methods, POS terminals, and scanners presented herein and below may include all or some combination of the components shown in the context of the checkout station 200. Further, although a checkout station 200 is illustrated as including a scanner 208, the scanner 208 may be a standalone element or an element of other systems, devices, and terminals in other embodiment. Examples of other terminal-types that may include a scanner 208 are self-service terminals (SSTs), clerk operated and self-service library checkout stations, time-keeping terminals, Pay-at-the-Pump terminals on a fuels pump at a fueling station, and the like. Also, scanner 208 may also include or be a handheld scanner that is connected to the POS system via a wired or wireless connection. Additionally, in some embodiments another device, such as a camera of a mobile device, may be utilized in place of a camera to capture images of products presented for purchase.

The methods of some embodiments are programmed as executable instructions in memory and/or non-transitory computer-readable storage media and executed on one or more processors and other such data processing devices associated with the components and devices herein.

The checkout station 200 includes one or more POS displays 202 that present information of a POS system 204 coupled to the one or more POS displays. Information presented by the one or more POS displays includes information relevant in a retail context and with regard to operation of the checkout station. The POS displays 202 may include a customer-facing display on which transaction related information, including promotion information about items offered for sale which may be in close proximity to the checkout station 200. In some embodiments, when promotion data presented on the customer-facing display, or as otherwise maybe communicated to a customer, a wired or wireless communication interface 206 may be utilized to send an activation signal to a product attraction feature device located in proximity to a product that is the subject of presented promotion data. The product attraction feature device may be a light emitting diode array that blinks when activated or other device that outputs an audible or visual signal to gain the attention of the customer. In some embodiments, the product attraction feature device includes a display that presents information about the product and the promotion data, in some embodiments.

The checkout station 200 also includes the scanner 208. The scanner 208 may be referred to as a barcode scanner as that is the task most commonly associated with such devices. An example of such a barcode scanner is the NCR RealScan™ 7879 Bi-Optic Imager available from NCR Corporation of Duluth, Ga. During operation of the checkout station 200, items are placed within a scan field of the scanner 208. One or more scanning devices 218 of the scanner 208, such as one or more of a camera and a laser scanner then scan a barcode and information read therefrom is communicated to the POS system 204. The POS system 204 then uses that data to identify the item placed within the scan field of the scanner 208 and performs an additional function. The additional function may include a price lookup and addition of the item to a list of items to be purchased, which may be presented on the one or more POS displays 202.

The scanner 208 may include one or more scan fields, such as two scan fields of bi-optic scanners that are commonly seen in grocery and discount retail outlets. In addition to the scanning devices 218, the scanner 208 may include various other components. The various other components may include an integrated scale 210 such as may be used in a grocery outlet to weigh produce and one or both of a speaker 212 and display lighting 216 to output audio or visual signals such as signals of (un)successful scans. The scanner 208 may also include scan field lighting 220 that may be turned on and off and adjusted based on a detected presence of an item to be scanned.

During typical operation, the scanner 208 is operated according to instructions executed on a processor 222. The processor may be an application integrated circuit (ASIC), digital signal processor, microprocessor, or other type of processor. The instructions may be firmware 226 or software 230 stored in one or more memories 224. The one or more memories 224 may be or include volatile and non-volatile memories, write-protected memories, write-once memories, random access memory (RAM), read only memories (ROM), and other memory and data storage types and devices.

The instructions as may be stored in firmware 226 or as software 230 in memory 224 are executed according configuration settings stored in the memory 224. The configuration settings 228 configure operation of the scanner 208, the various components, both hardware and software, therein. For example, the configuration settings 208 may configure speaker 212 volume, display lighting 216 outputs, scan field lighting 220 brightness, decoding algorithm of the scanning device(s) 218 and the instructions, one or more communication protocols used to communicate data from the scanner 208 to the POS system 204, such as via the wired or wireless communication interface 206 of the POS system 204 to a physical communication interface device 214 or virtualized communication interface 232 of the scanner 208. For example, in some embodiments, the communication interface 206 of the POS system 204 is accessible from the scanner 208 as a virtualized communication interface 232 as may be maintained in the memory 224 by a process that executes on the processor 222. Each of the communication interfaces 206, 214 may be wired or wireless communication interface devices, such as a wired Ethernet device, a wireless Ethernet device (e.g., a device capable of communicating according to one or more of the 802.11 standards), Bluetooth® device, a mesh network device or other peer-to-peer type networking device, a mobile network data communication device, and the like.

In some embodiments, the software 230 stored in memory 224 includes instructions executable on the processor 222 to automatically set the configuration settings 228, such as upon scanner 208 installation, completion of scanner 208 maintenance, or other times with regard to the scanner 208. In some embodiments, the software 230 stored in the memory 224 includes instructions executable by the processor 222 to receive an image from a scanner, identify the presence of a currency bill in the image by comparing parameters of currency item profiles with the image. The currency item profiles, in some embodiments, are stored in the configuration settings 228 of the scanner 208 or within a memory of the POS system 204. The image in some embodiments, may be processed in the scanner 208 or may be provided by the scanner 208 to the POS system 204 which then processes the image. The parameters of a currency item profile include parameters that define a currency item, such as graphical elements and other features that are present on a currency item. A currency item profile also includes data identifying a denomination and a denomination value of the currency item. Thus, when a currency item profile has been matched to an image, the denomination and value of the currency is then also known.

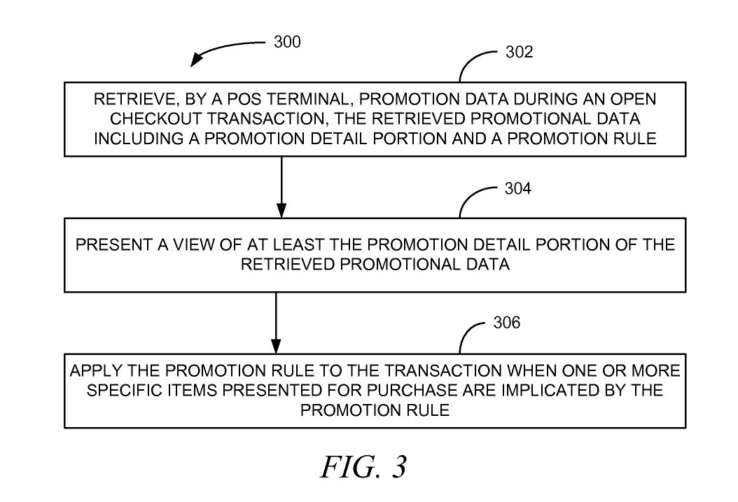

FIG. 3 is a block flow diagram of a method 300, according to an example embodiment. The method 300 is an example of a method that may be performed by a POS terminal while a transaction is being conducted. The POS terminal may be a cashier operated terminal, a Self-Service Terminal (SST), a mobile device executing a POS app, and the like.

The method 300 includes retrieving 302, by POS terminal, promotion data during an open checkout transaction. The retrieved 302 promotional data typically a promotion detail portion and a promotion rule that identifies conditions within the transaction for when the promotion applies, such as purchase of one or a combination of products, and then what action to take when the rule is satisfied, such as a price adjustment, adding points to a customer loyalty account, adding on a free item, and the like.

The method 300 further includes presenting 304 a view of at least the promotion detail portion of the retrieved promotional data. The presenting 304 may include presenting the view on a display of the POS terminal to the cashier or on a customer-facing display to the customer. The presenting may further or also include transmitting a message to a mobile device of the customer when the customer is known, such as via earlier presentment of customer loyalty account identifying data. The message may be a text message, an in-app message, and the like.

The method 300 also includes applying 306 the promotion rule to the transaction when one or more specific items presented for purchase are implicated by the promotion rule.

In some embodiments, the method 300 may additionally include receiving customer identifying data and retrieving 302 the promotion data based at least in part on the customer identifying data. For example, when the customer is known to be a purchaser of certain items located in proximity to the POS terminal, such as a candy bar or soda, a candy or soda promotion may be identified based on the customer's identify and known preference and like that may be represented in association with the customer's loyalty account.

In these and some other embodiments, the method 300 includes receiving input of data identifying an item presented for purchase, such as by scanning a barcode of the item and retrieving 302 the promotion data based at least in part on the data identifying the item presented for purchase. For example, when a customer presents one item, one or more other items may be commonly purchased therewith. Such one or more items may then be the subject of a promotion.

In some embodiments, the promotion data is stored to and retrieved from local data storage of the POS terminal. Further, the promotion data may be subject to input data received over a network with regard to prioritization of promotion data to retrieve. For example, one or more items may be of particular significance and those items will be presented before other items in promotion data. In some such embodiments, the promotion data may include variables with regard to products for which promotion data is associated, such as a day of the week variable that makes a promotion data item higher ranked. This may be with regard to magazines where a new edition comes out every Friday. Through such a variable, the magazine can have a high priority for promotion on Thursday to move all remaining copies while they are still current. Another variable may include an inventory variable such that when no further stock is available, the product has a very low priority. A weather variable may also be utilized, such as with regard to cold drinks and ice cream on hot days and coffee and hot chocolate on cold days. Additionally, another variable may be with regard to closeness in proximity to the POS terminal. Items located more closely may be of higher priority. One or more rules may be applicable to a particular product and allow for optimization of item promotions offered to customers.

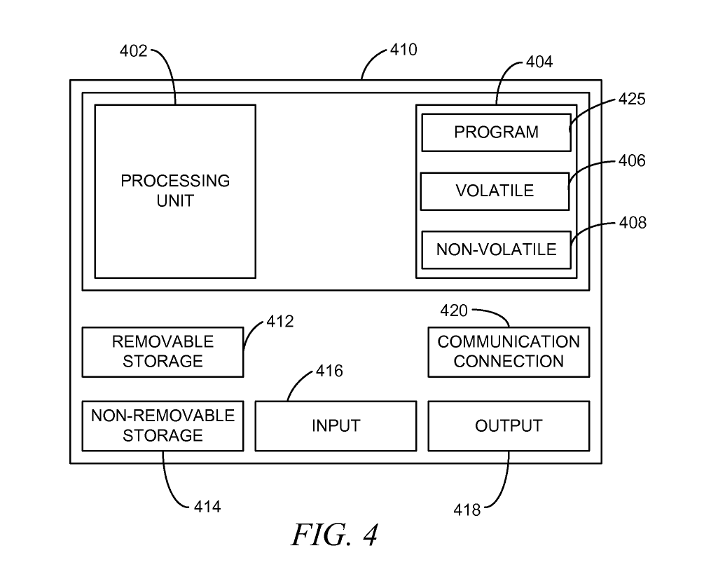

FIG. 4 is a block diagram of a computing device, according to an example embodiment. In one embodiment, multiple such computer systems are utilized in a distributed network to implement multiple components in a transaction-based environment. The illustrated computing device may be implemented as a POS system 204 of FIG. 2 in some embodiments. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be a smartphone, a tablet, smartwatch, or other computing device including the same or similar elements as illustrated and described with regard to FIG. 4. Devices such as smartphones, tablets, and smartwatches are generally collectively referred to as mobile devices. In some embodiments, some such mobile devices may be implemented as POS terminals with an app that executes thereon. Further, although the various data storage elements are illustrated as part of the computer 410, the storage may also or alternatively include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, one or more device-specific buttons, one or more sensors integrated within or coupled via wired or wireless data connections to the computer 410, and other input devices. The computer 410 may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 420 may also or alternatively include a transceiver device, such as a BLUETOOTH® device that enables the computer 410 to wirelessly receive data from and transmit data to other BLUETOOTH® devices.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
retrieving, by a Point-of-Sale (POS) terminal, promotion data during an open checkout transaction, the retrieved promotional data including a promotion detail portion and a promotion rule;
presenting a view of at least the promotion detail portion of the retrieved promotional data; and
applying the promotion rule to the transaction when one or more specific items presented for purchase are implicated by the promotion rule.

2. The method of claim 1, further comprising:
receiving customer identifying data; and
retrieving the promotion data based at least in part on the customer identifying data.

3. The method of claim 1, further comprising:
receiving input of data identifying an item presented for purchase; and
retrieving the promotion data based at least in part on the data identifying the item presented for purchase.

4. The method of claim 1, wherein the POS terminal is a Self-Service Terminal (SST) terminal.

5. The method of claim 1, wherein the promotion data is stored to and retrieved from local data storage of the POS terminal.

6. The method of claim 5, wherein the promotion data is subject to input data received over a network with regard to prioritization of promotion data to retrieve.

7. The method of claim 5, wherein the promotion data includes variables with regard to products for which promotion data is associated.

8. The method of claim 7, wherein the variables include at least one of a day of the week variable associated with at least one product, a product inventory variable associated with at least one product, a weather variable associated with at least one product, and a proximity to the POS terminal variable.

9. A method comprising:
retrieving, by a Point-of-Sale (POS) terminal, promotion data during an open checkout transaction, the retrieved promotional data including a customer display portion and a promotion rule;
presenting, on a customer-facing display of the POS Terminal, a view of at least a portion of the retrieved promotional data; and
applying the promotion rule to the transaction when one or more specific items presented for purchase are implicated by the promotion rule.

10. The method of claim 9, wherein the implicated promotion rule, when applied, adjusts a price of at least one item presented for purchase within the POS terminal transaction.

11. The method of claim 9, further comprising:
transmitting a command to an attraction feature associated with a product near the POS terminal as referenced in the customer display portion of the retrieved promotion data.

12. The method of claim 11, wherein the attraction feature is a radio device including a light element that illuminates when a radio signal is transmitted by a radio transceiver device of the POS terminal.

13. The method of claim 9, further comprising:
receiving customer loyalty account identifying data; and
retrieving the promotion data based at least in part on the customer account identifying data.

14. The method of claim 9, further comprising:
receiving input of data identifying an item presented for purchase; and
retrieving the promotion data based at least in part on the data identifying the item presented for purchase.

15. A POS terminal comprising:
at least one processor, at least one memory device, and at least one display;
an instruction set stored on the at least one memory device and executable by the at least one processor to perform data processing activities comprising:
retrieving promotion data during an open checkout transaction, the retrieved promotional data including a promotion detail portion and a promotion rule;
presenting a view of at least the promotion detail portion of the retrieved promotional data; and
applying the promotion rule to the transaction when one or more specific items presented for purchase are implicated by the promotion rule.

16. The POS terminal of claim 15, further comprising:
a customer-facing display; and
wherein presenting the view of at least a portion of the retrieved portion data includes presenting the view on the customer-facing display.

17. The POS terminal of claim 15, further comprising:
a radio transceiver device; and
wherein the instruction set is further executable by the at least one processor to perform data processing activities comprising:
transmitting, via the radio transceiver device, a command to an attraction feature associated with a product near the POS terminal as identified in promotion detail portion of the retrieved promotion data.

18. The POS terminal of claim 15, further comprising:
a network interface device; and
wherein retrieving the promotion data includes retrieving the promotion data via the network interface device from a remote source.

19. The POS terminal of claim 18, further comprising:
at least one input device; and
wherein the instruction set is further executable by the at least one processor to perform data processing activities comprising:
receiving customer loyalty account identifying data via the at least one input device; and
wherein retrieving the promotion data includes transmitting the customer loyalty account identifying data in a query to the remote source for the promotion data to receive promotion data tailored specifically to a customer of the customer loyalty account identifying data.

20. The POS terminal of claim 19, wherein the instruction set is further executable by the at least one processor to perform data processing activities comprising:
receiving, via the at least one input device, data identifying an item presented for purchase; and
wherein retrieving the promotion data is further performed based at least in part on the data identifying the item presented for purchase.
